(19) United States
(12) Patent Application Publication
(10) Pub. No.: US 2011/0123902 A1
(43) Pub. Date: May 26, 2011

(54) Permselective Membrane-Free Direct Fuel Cell and Components Thereof

(76) Inventors: Ruiming Zhang, Cheyenne, WY (US); John Pope, Laramie, WY (US); Yinghui Pan, Cheyenne, WY (US)

(21) Appl. No.: 12/919,214

(22) PCT Filed: Feb. 25, 2009
(86) PCT No.: PCT/US09/35189

§ 371 Date: Aug. 24, 2010

Related U.S. Application Data
(60) Provisional application No. 61/031,250, filed on Feb. 25, 2008.

(51) Int. Cl. H01M 8/22; H01M 4/583; H01M 8/04

(52) U.S. Cl. 429/506; 429/512

(57) ABSTRACT

There is disclosed a direct fuel cell comprising an anode and a cathode immersed in an electrolyte in the presence of a reductant and oxidant. Specifically, the fuel cell lacks a permselective membrane or other chemical barrier between the anode and cathode. Instead, the fuel cell has a mechanical/electrical porous separator that permits the free diffusion of liquid between all elements of the fuel cell. The fuel cell further contains an anode electrode of conductive substrate with catalyst and a cathode comprising a hydrophobic coated material that prevents cathode flooding. As a result, oxidation of the anode fuel and reduction of the cathode fuel occur to a substantial extent only at the anode and cathode, respectively, and is capable for ambient pressure/temperature and passive operation.

### CROSS REFERENCE TO RELATED APPLICATION

This patent application claims priority from U.S. provisional patent application 61/031,250 filed on 25 Feb. 2008.

The present invention was made under a subcontract from the Department of Defense. The government has certain rights to this invention.

### TECHNICAL FIELD

This disclosure is directed to a fuel cell and to a Separator-Electrode Assembly (SEA) that is used in a permselective membrane-free liquid fuel cell. Specifically, the disclosed fuel cell operates for an extended period of time using alcohols, preferably ethanol, as a carbon-based fuel source and air, and provides further advantages in that it does not require a permselective membrane, does not use expensive platinum as a catalyst, and does not require operating temperatures above general ambient temperature. More specifically, the fuel cell lacks a permselective membrane or other physical or perm-selective liquid barrier between the anode and the cathode and instead employs a separator as a part of an SEA (separator electrode assembly). Instead, the SEA includes a porous separator assembly (instead of a perm-selective membrane) that permits the free and unselective diffusion of liquid and electrolyte between all elements of the fuel cell. The fuel cell further comprises a selective anode (electrode) having a substrate and a catalyst, and a selective cathode comprising a hydrophobic coated material that prevents cathode flooding. As a result, oxidation of the anode fuel (an alcohol, preferably ethanol) and reduction of the cathode fuel occur to a substantial extent only at the anode and cathode, respectively. Additionally, the cathode catalyst has very limited reactivity with the anode fuel, which selectivity improves the performance of the fuel cell. Moreover, the SEA allows for stacking the fuel cells and hence a greater power output. The present disclosure further provides a cathode for use in the disclosed SEA that can withstand cathode flooding and still operate effectively. The present disclosure further provides an anode Pd on carbon catalyst that operates more effectively at about 8% Pd than commercial Pd on carbon catalysts that have approximately 30% Pd to provide a more cost-effective anode solution for a liquid fuel cell.

### BACKGROUND

A fuel cell is an electrochemical device that converts chemical energy into electrical energy. In terms of such energy conversion, fuel cells may look similar to batteries and combustion engines that are used to generate electrical energy. But unlike batteries, fuel cells can produce electricity as long as they are supplied with a fuel. Besides, in contrast to combustion engines, fuel cells can produce electricity directly from electrochemical reactions without multiple energy conversions, including heat and mechanical motions. In a typical fuel cell, a fuel is provided to the anode and oxidized, releasing protons and electrons. The generated electrons pass through an external load to do electrical work and travel back to the cathode, whereas the protons migrate across an electrolyte membrane that is selectively permeable to protons, in other words, ‘permselective’ to the cathode. In the cathode, an oxidant is supplied and reduced with the protons and electron's, creating pure water as a by-product.

Fuel cells have several important advantages over conventional electrical energy generation devices. Fuel cells are simple in construction, with few moving parts. Due to this uncomplicated structure, fuel cells can be reliable and long-lasting; it makes fuel cells silent as well. In addition to those benefits, fuel cells from which water would be the only by-product are environmentally friendly. Besides, in contrast to batteries, fuel cells have continuous operation capability by refueling.

It should be noted that the permselective membrane, such as Nafion, is often among the most expensive component of conventional fuel cells, particularly if Pt or Ru is also used.

After cost, fuel supply is the next greatest problem for fuel cells. Hydrogen is the most preferred fuel of fuel cells due to its high reactivity for the anode oxidation reaction and lack of any emission other than pure water. However, hydrogen does not occur naturally as do fossil fuels, and so over 95% of hydrogen is currently produced from fossil or other petrochemical sources such as methane (CH₄), ammonia (NH₃), methanol (CH₃OH), ethanol (C₂H₅OH), gasoline (C₈H₁₈), and similar hydrocarbons (T. E. Lipman, “What Will Power the Hydrogen Economy? Present and Future Sources of Hydrogen Energy,” Institute of Transportation Studies, Davis, Calif., Tech. Rep. UCD-ITS-RR-04-10, 2004).

In order for fuel cells to be broadly adopted, they need to provide useful power using readily available fuels and to be constructed from inexpensive materials. Currently available fuel cells do not satisfy these requirements. Alkaline fuel cells can provide useful power and can be constructed from inexpensive materials. However they use hydrogen as an anodic fuel, which is expensive and difficult to handle. In addition, in some cases they operate at high temperatures (up to 250° C.) and can require expensive thermal management systems. Finally, alkaline fuel cells cannot tolerate even small amounts of carbon dioxide, and so the fuels must be scrubbed prior to use, or the electrolyte must be refreshed during operation. As a result of these drawbacks, alkaline fuel cells are not widely used.

Direct borohydride fuel cells are a subset of alkaline fuel cells. In those cells, sodium borohydride is used as a direct anodic fuel. However, even in alkaline media sodium borohydride hydrolyzes to produce hydrogen gas. In direct borohydride fuel cells, this reaction reduces the amount of borohydride available to react at the anode, and the produced hydrogen gas must be managed safely. As a result of these drawbacks, direct borohydride fuel cells are not widely used.

Phosphoric acid fuel cells can provide useful power using natural gas. They require no perm-selective membrane and their operating temperature ranges from 150° C. to 250° C., high enough that hydrogen reformed from natural gas, and containing trace impurities, can be used directly as an anodic fuel. However, they use expensive platinum as a catalyst and substantial balance of plant costs for reforming and for thermal management. As a result of these drawbacks, phosphoric acid fuel cells are not widely used.

Solid oxide fuel cells can provide useful power using readily available fuels such as natural gas. They use a perm-selective solid electrolyte membrane and their operating temperature can range as high as 1000° C., high enough that natural gas can be used directly as an anodic fuel if highly pure and without sulfur. In addition, their high operating temperatures create difficulties in finding suitable structural and electronically conducting materials for use in the cells. Those temperatures also create substantial thermal management costs. As a result of these drawbacks, solid oxide fuel cells are not widely used.

Polymer electrolyte, or proton exchange, membrane fuel cells can provide useful power. They typically operate at temperatures ranging from room temperature to 80° C., low enough that materials selection and thermal management issues are tractable. However, they use expensive platinum as catalysts. They use hydrogen as an anodic fuel, which is expensive and difficult to handle. Their platinum catalysts are not tolerant of impurities in the hydrogen, so they are difficult to use with hydrogen reformed from other fuels such as natural gas. In order to avoid depolarization of the cells by reaction of hydrogen at the cathode catalyst, they require the use of perm-selective electrolyte membranes, typically constructed from perfluorinated materials such as Nafion®, which is expensive. In order to deliver gaseous fuels to both the anode and the cathode, they require complex manifolds and input pressures as high as three atmospheres, increasing the mechanical design and materials costs of the cells. As a result of these drawbacks, polymer electrolyte fuel cells are not widely used.

Direct methanol fuel cells can provide power from a readily available and inexpensive fuel, methanol. They typically operate at temperatures ranging from room temperature to 80° C., low enough that materials selection and thermal management issues are tractable. Since the anodic fuel is a liquid, the volumetric energy density of direct methanol fuel cells can be much higher than cells that use hydrogen gas, such as polymer electrolyte fuel cells. However, they use expensive platinum in their catalysts, and at very high loadings. They suffer from poisoning of the catalysts by intermediate reaction products at the anode. They are depolarized by crossover of methanol from the anode to the cathode. They suffer from decreased fuel utilization due to that crossover, as well. They require the use of expensive perm-selective membranes to reduce crossover of methanol to the cathode. Such membranes do not operate properly in fluids containing high methanol concentrations, and so the anodic fuel concentration must include substantial amounts of water, decreasing the energy density of the cell. As a result of these drawbacks, direct methanol fuel cells are not widely used.

Xiaoming Ren (9^{th} Annual International Symposium: Small Fuel Cells 2007; Mar. 9, 2007; Knowledge Foundation) report an alkaline fuel cell developed by Acta S.p.A. that utilizes “platinum-free” anode catalysts together with a variety of anode fuels including ethanol, methanol, ethylene glycol, and glycerol, among others. The author reported a fuel cell that used 10% ethanol in 10% potassium hydroxide in water as the anodic fuel and ambient air as the cathodic fuel and that produced 28 mW per cm² at room temperature and 145 mW per cm² at 80° C. However, the cell included an expensive perm-selective membrane as part of its construction. This fuel cell does not use inexpensive materials.

Finkelshtain et al. report (U.S. 2003/0008199) a brief description of a fuel cell developed by Medis EL Ltd. that uses a transition metal-conducting polymer catalyst for the anode and cathode catalysts, and 30% methanol in water and an unknown fuel as the anodic and cathodic fuels, respectively. The fuel cell did not include a perm-selective membrane. The authors claim that the resultant fuel cell produced “a power density of 25 to 30 mW/cm² over several hours.” No operating temperature or actual data was disclosed. However, this fuel cell used platinum in both its anode and cathode. This fuel cell does not use inexpensive materials, and specifics of its power performance and cathodic fuel have not been disclosed.

Medis Technologies LTD also has commercialized a fuel cell that presumably can be used to recharge and/or power mobile phones. While those fuel cells are labeled as direct sodium borohydride cells, disassembly and analysis of a purchased unit direct from Medis revealed them to be an alkaline fuel cell in which the hydrogen anodic fuel is delivered by uncontrolled hydrolysis of the borohydride. These fuel cells contain substantial amounts of platinum in their anodes, to the point where the purchase price of the fuel cell was lower than the cost of the platinum contained in the anode. Some portion of the power appears to result from galvanostatic reduction of the manganese oxide cathode catalyst. In addition, the cells do not manage the hydrogen gas that they spontaneously produce, and as such they pose serious safety risks. These cells do not use inexpensive materials and are unsafe as currently sold.

Portable power systems are considered to be an upcoming market where various fuel cell systems will have a commercial application. However, only perm-selective membrane based (that is, an electrolyte membrane that is selective to a particular ionic species, such as protons) can provide the power densities needed for portable power systems that can be used to charge mobile phones, PDA's and laptops for extended periods of time. Yet, such perm-selective membrane fuel cell systems suffer from problems of high cost (due to the high cost of the perm selective membrane), need for copious quantities of expensive catalyst materials (such as Pt or Ru), and poor life-span due to generation of carbon monoxide and other intermediate chemical species that poison the catalyst. Alkaline fuel cells suffer from poor life-span because of carbon dioxide that forms carbonates with the electrolyte solution and clogs the permselective membrane with precipitating carbonate salts. Therefore, there is a need for fuel cells for portable power applications that can achieve needed power densities but lack permselectiv] membranes.

One such attempt to set up a prototype cell that lacks a membrane was reported in Verma and Basu (J. Power Sources 145:282-285, 2005). The Verma and Basu authors tried to use methanol and ethanol as fuels in a stationary bench top cell that required no movement and careful placement of the cathode in a horizontal orientation so as to avoid cathode flooding. However, such a design required a constant stirring at the anode, no portability as any shaking in the liquid electrolyte/fuel mixture would flood the cathode (i.e., no portability) and the current densities for ethanol was a meager 2 mA/cm², at best, with only minutes of run time.

Therefore, there is a need in the fuel cell art to design more reliable fuel cells with less expensive materials that provide power for longer periods of time and at current densities greater than 2 mA/cm². The present disclosure was made to accomplish those goals.

### SUMMARY

The present disclosure is a fuel cell design that lacks a membrane, has a high current and power density and is able to run continuously, without stopping to regenerate catalyst. Moreover, the present disclosure identified a fuel cell design that can provide a current density of greater than 10 mA/cm² using a permselective membrane-free design. Specifically, the present disclosure provides a fuel cell that lacks a membrane, comprising:

(a) an enclosed fuel cell having an anode chamber and a cathode chamber, wherein the anode chamber is separated from the cathode chamber by a mechanical/electrical porous separator that allows the free transfer of liquids and ions between the chambers;

(b) the anode chamber comprises an anode electrode having a catalyst thereon, and a mixture of fuel and an electrolyte; and

(c) the cathode chamber comprises a hydrophobic coated cathode electrode having a catalyst thereon and oxygen gas or air; and

wherein the anode electrode and the cathode electrode are electrically connected to leads for current flow, and wherein the enclosed fuel cell is capable of producing at least 10 mA/cm².

Preferably, the fuel cell is capable of current densities of at least 15 mA/cm², or at least 20 mA/cm², or at least 25 mA/cm², or at least 30 mA/cm², or at least 35 mA/cm², or at least 40 mA/cm², or at least 1 A/cm². Preferably, the catalyst on the anode electrode is present at a density of no more than 1 mg/cm². Preferably, the fuel cell has a rate of voltage decay of less than 100 mV/hr and most preferably the fuel cell has a rate of voltage decay of about 50 μV/hr. with continuous operation. Preferably, the fuel cell can operate in any orientation, or with the fuel/electrolyte mixture pumped or added in a batch system. Preferably, the fuel cell power density output is at least 2 mW/cm². Preferably, the fuel cell is capable of running continuously for greater than 2 hours, more preferably, greater than 200 hours, more preferably, greater than 500 hours and most preferably for greater than 1000 hours.

Preferably, the fuel mixture comprises an alcohol, borohydride, hydrazine or poly-alcohol or a mixtures of alcohols at a concentration of from about 5% (by volume) to about 100% (by volume). More preferably, the concentration of alcohol or poly alcohol is from about 10% to about 50% by volume. Preferably, the fuel mixture further comprises an electrolyte wherein the electrolyte is selected from the group consisting of a base, an acid, a non-aqueous base, a non-aqueous acid. More preferably, the electrolyte is an aqueous base, wherein the pH is sufficiently high to completely ionize the alcohol. Most preferably the fuel is ethanol or methanol. Preferably, the coated electrode cathode is coated by a hydrophobic polymer selected from the group consisting of polyamides, polyimides, fluoropolymers, organosubstituted silica, organo-substituted titania, and combinations thereof.

Preferably, the fuel cell operates at a temperature less than 40° C. and most preferably at a temperature of from about 20° C. to about 40° C.

The present disclosure further provides a fuel cell lacking a permselective membrane for the separation of the cathode and anode and the attendant redox reactants associated with the cell. More specifically, the present disclosure provides a fuel cell comprising:

(a) an anode compartment comprising a fuel mixture, an anode electrode and an anode catalyst, wherein the fuel is aqueous and mixed with an electrolyte, and wherein the anode electrode is a substrate electrode having catalyst particle embedded therein;

(b) a cathode compartment having an air inlet, a conductive and coated electrode cathode, wherein the cathode electrode coating is hydrophobic, and wherein a catalyst material is further embedded within the conductive coated cathode electrode; and

(c) a porous separator located between the anode and the cathode that allows for the free movement of aqueous liquids and electrolyte ions. Preferably, the conductive cathode electrode coated hydrophobic material prevents flooding of the cathode.

Preferably, the fuel mixture comprises an alcohol or poly-alcohol at a concentration of from about 5% (by volume) to about 50% (by volume). Most preferably the fuel is ethanol or methanol. Preferably, the coated cathode electrode is coated by a hydrophobic polymer selected from the group consisting of polyamides, polyimides, fluoropolymers, organosubstituted silica, organo-substituted titania, and combinations thereof. Preferably, the porous separator is a porous ceramic, glass fiber or woven porous sheet.

The present disclosure provides separator electrode assembly (SEA) for a permselective membraneless fuel cell that provides improved yields for fuel cell assembly into a unitized assembly and avoids seals and compressions characteristic of MEAs (membrane electrode assemblies) characteristic of permselective membrane-based fuel cells. Specifically, the present disclosure provides a Separator Electrode Assembly (SEA) comprising a plurality of multiple-layered sandwich assemblies located within a chamber, wherein each multiple layered sandwich assembly comprises:

(a) a substantially flat and substantially planar anode having a first and a second side, wherein the first side communicates with a reservoir of fuel; communicating on one side with a flat and planar porous separator that, in turn communicates with a flat and planar cathode

(b) a substantially flat and substantially planar porous separator having a first side and a second side and that allows passage of liquids and electrolytes relatively unimpeded, wherein the first side of the porous separator communicated with the second side of the anode; and

(c) a substantially flat and substantially planar cathode having a first and a second side, wherein the first side communicates with the porous separator and the second side communicates with air or an oxygen gas source, wherein the cathode further comprises a hydrophobic coating; and

wherein the chamber comprises an enclosed chamber having liquid fuel in communication with the first side of each anode and air or oxygen gas in communication with the second side of each cathode.

Preferably, the chamber is formed with a circumferential thermoplastic assembly formed under melt-flow conditions. Preferentially, the SEA is further sealed to a bipolar plate to form a unitized assembly.

### BRIEF DESCRIPTION OF DRAWINGS

FIG. 1 illustrates a cell polarization curve for a preferred embodiment of the disclosure wherein the anode is comprised of palladium nanoparticles immobilized on carbon particles pressed into a nickel foam, the cathode is comprised of cobalt and carbon particles pressed into a carbon foam, the electrolyte is ten percent potassium hydroxide in water, the fuel is ten percent ethanol, and the cathodic reactant is ambient air. There is no permselective membrane used in the fuel cell. The data show a peak power density of about 44 mW/cm², or a superior permselective membrane-less fuel cell output. FIG. 1 further shows voltage when the current is increased. These data were obtained at a high altitude location wherein the atmospheric pressure was 11.68 psi versus 14.7 psi at sea level.

FIG. 2 illustrates cell voltage for a preferred embodiment wherein the anode is comprised of palladium nanoparticles immobilized on carbon particles pressed into a nickel foam, the cathode is comprised of cobalt and carbon particles pressed into a carbon foam, the electrolyte is ten percent potassium hydroxide in water, the anodic reactant is ten percent ethanol, and the cathodic reactant is ambient air. The FIG. 2 fuel cell is the same arrangement as the membrane-less fuel cell in FIG. 1, but running at 50 mA/cm² constant current density running continuously (without any catalyst regeneration) for about 1000 hours. At the time of filing the present provisional patent application, this fuel cell had achieved 3746 hours of continuous operation. These data were obtained at a high altitude location wherein the atmospheric pressure was 11.68 psi versus 14.7 psi at sea level.

FIG. 3 illustrates cell voltage and power and cell polarization curve for a preferred embodiment wherein the anode is comprised of nickel, zinc and palladium particles pressed into a nickel foam, the cathode is comprised of cobalt and carbon particles pressed into a carbon foam, the electrolyte is ten percent potassium hydroxide in water, the anodic reactant is ten percent ethanol, and the cathodic reactant is ambient air. The data show the power density and anode and cathode potentials to determine which electrodes might show any degradation. These data show that the preferred embodiment fuel cell is cathode limited. These data were obtained at a high altitude location wherein the atmospheric pressure was 11.68 psi versus 14.7 psi at sea level.

FIG. 4 illustrates comparative curves for two different fuel cell architectures. The closed squares are a commercial anode and a commercial cathode with a permselective membrane (membrane is OH-hydroxyl ion exchange permselective membrane). The triangles curve is the “NDC Modified cathode electrode without a permselective membrane” according to the present disclosure. These comparative data show that the disclosed fuel cell architecture, using the disclosed separated cell assembly (SEA), produces comparable power density to a traditional permselective membrane-based fuel cell. Yet the disclosed fuel cell architecture with the SCA was able to provide continuous power output (without the need to regenerate catalyst) for significantly longer periods of time that traditional permselective membrane-containing fuel cells. These data were obtained at a high altitude location wherein the atmospheric pressure was 11.68 psi versus 14.7 psi at sea level.

FIG. 5 shows a schematic of disclosed fuel cell having the separated cell assembly (SCA). Specifically, the fuel and fuel reservoir are located to the left of the anode and comprise a chamber having liquid fuel mixed with electrolyte. The anode is itself porous and comprises part of the SCA. The anode sandwiches one side of the porous separator, allowing liquid and gas to freely pass both porous structures (anode electrode and porous separator). The other side of the SCA is the cathode electrode that has a microporous layer (MPL) on the side of the porous separator.

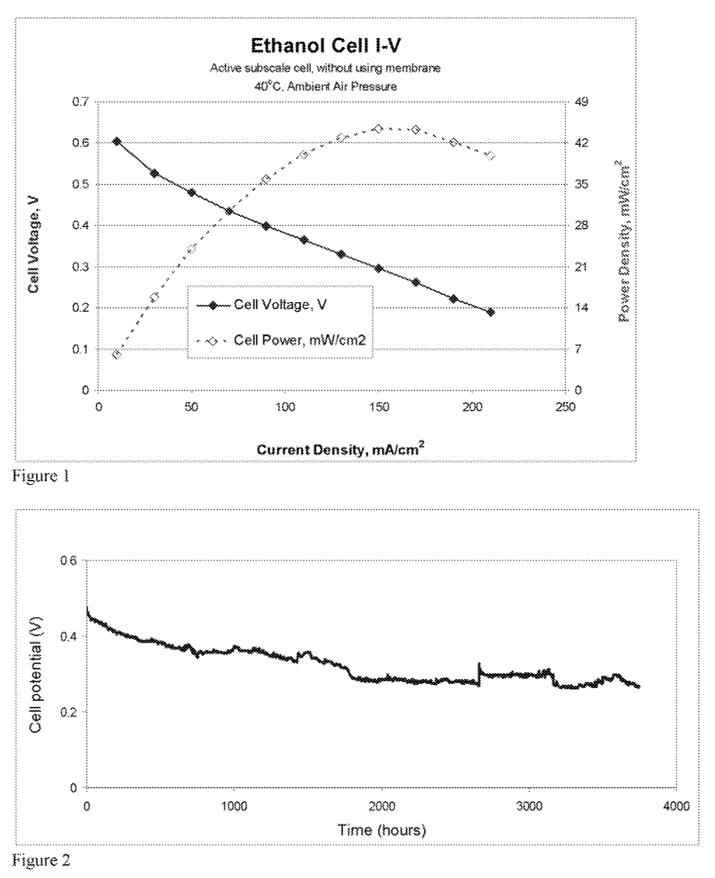

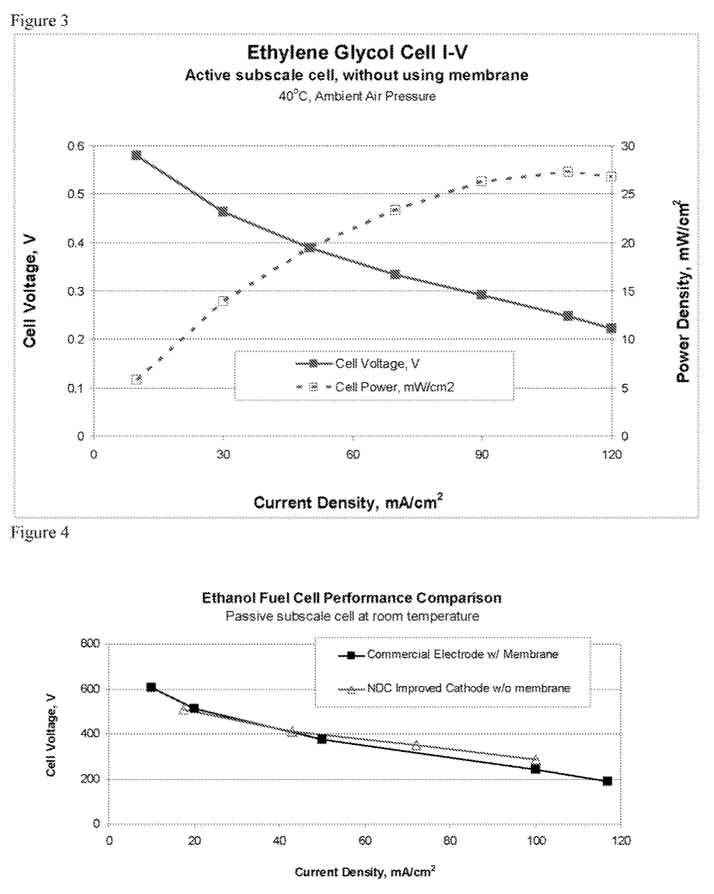

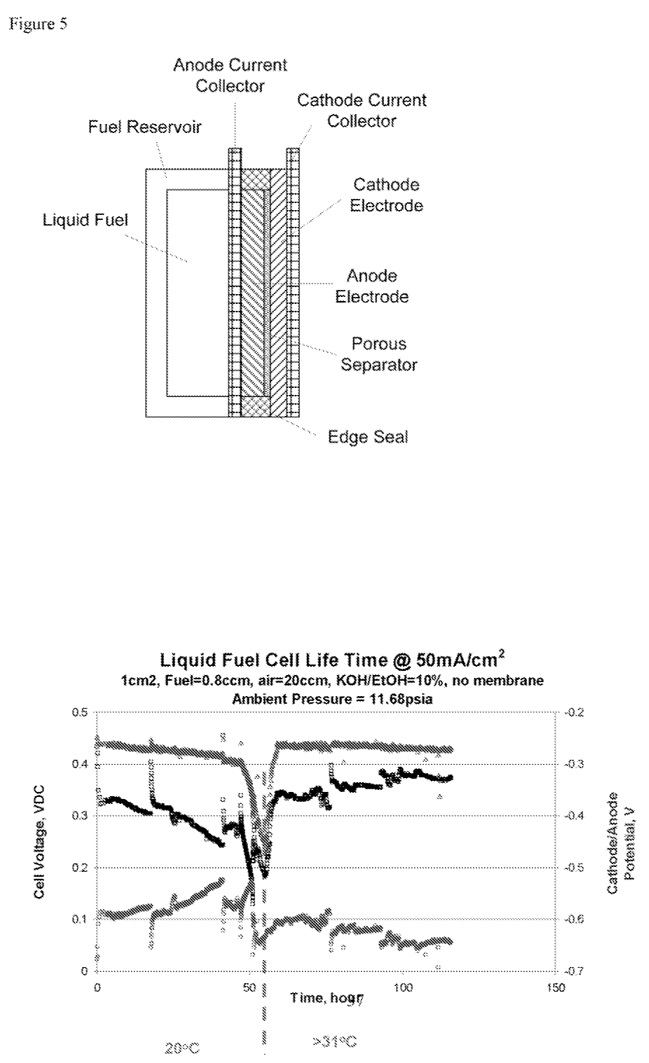

### DETAILED DESCRIPTION

### Definitions

The term “power density” as used herein, refers to the calculation of mW/cm², wherein a watt (W) is amps time voltage. The calculation of area (in cm²) is made from the smaller area of the anode or the cathode in the disclosed fuel cell. The present disclosure fuel cell achieved a hereinbefore never achieved power density of greater than 10 mW/cm², preferably greater than 15 mW/cm². preferably greater than 20 mW/cm², or preferably greater than 25 mW/cm² at room temperature.

The term “catalyst loading” refers to the weight of the catalyst material added to the anode electrode or electrode per unit area (of anode or cathode).

The disclosure provides a fuel cell that lacks a permselective membrane or other chemical barrier between the anode and cathode. As permselective membranes, particularly an anionic perfluorinated sulfonic acid permselective membrane, such as Nafion®, represent a significant cost of a fuel cell, the present disclosure provides an advantage in significantly reducing the cost of components of a fuel cell by eliminating the permselective membrane cost. Typical fuel cells consist of a cathode compartment containing a cathode, an anode compartment containing an anode, and a membrane that separates the two compartments. The permselective membrane is typically a permselective ion exchange membrane; in the case of an alkaline fuel cell, the permselective membrane conducts hydroxide ions and water. The anode and cathode are connected by an external conductor which can also pass through a load to produce useful work. Generally, each compartment contains an electrolyte into which the electrodes are immersed. In some cases, a fuel cell employs one or more fuels that are not liquid but gas phase. In those cases, the appropriate electrode is typically located at the physical interface between the gaseous fuel and the electrolyte.

In the present disclosure, the fuel cell comprises:

(a) an anode compartment comprising a fuel mixture, an anode electrode and an anode catalyst, wherein the fuel is aqueous and mixed with an electrolyte, and wherein the anode electrode is a substrate electrode (preferably carbon paper is the substrate) having catalyst particle embedded therein;

(b) a cathode compartment having an air inlet, a conductive and coated electrode cathode, wherein the cathode electrode coating is hydrophobic, and wherein a catalyst material is further embedded within the conductive coated cathode electrode; and

(c) a porous separator located between the anode and the cathode that allows for the free movement of aqueous liquids. Preferably, the conductive cathode electrode coated hydrophobic material prevents flooding of the cathode.

A key component is the coated conductive cathode, preferably having a hydrophobic microporous layer (MPL) adjacent to the porous separator. The MPL layer of the cathode can be made, for example, by immersing carbon paper in a fluoropolymer mixture, such as a Teflon (PTFE) emulsion. Once immersed, the polymer is sintered or heated to its glass transition temperature (347° F.) to make the conductive carbon paper hydrophobic. The cathode catalyst is added by a spray-on process or using an air brush.

In a further embodiment, the anode or the cathode is made with a carbon paper having a fluorocarbon layer to provide both a hydrophobic layer at the cathode to prevent cathode flooding but also to solubilize oxygen from air to provide an oxygen reservoir. A preferred fluorocarbon layer is PTFE (Teflon). In such a cathode, MnO₂ catalyst is first attached to carbon paper as the cathode and then the entire sheet is dipped into a melted PTFE solution.

The disclosed fuel cell can operate due to the selectivity of the catalysts. For example, using a short chain alcohol as the fuel in a 10% (range 2% to 25%) KOH (or other alkaline electrolyte solution) electrolyte solution (from about 2M to about 3M), the cell uses a palladium catalyst on the anode side and a cobalt (oxide) catalyst on the cathode side. Such a fuel cell can produce steady power output of approximately 44 mW per cm² area or approximately 44 mA per cm² of catalyst/electrode.

The fuel cell is distinguished in part by the absence of the permselective membrane or other chemical barrier between the anode and cathode. Removal of this permselective membrane is possible because the anode and cathode catalysts are chosen, together with their fuels and the supporting electrolyte, so that the anode and cathode fuels and the fuel cell electrolyte can intermingle without substantial chemical reaction. As a result, oxidation of the anode fuel and reduction of the cathode fuel occur to a substantial extent only at the anode and cathode, respectively. In addition, the anode and cathode catalysts are selective, so that the anode reaction is not influenced adversely by the presence of the cathode fuel (O₂) and the cathode reaction is not influenced adversely by the presence of the anode fuel (the alcohol or polyalcohol). These features of the anode and cathode catalysts also make removal of the membrane possible.

In preferred embodiments the anode and cathode fuels are selected from those classes of fuels that are most appropriate, based on availability, cost, safety, or other factors, for that particular application. The anode and cathode catalysts are then selected using a number of criteria:

(i) that the anode catalyst oxidizes the anode fuel at a potential and at a rate that produces the cell voltage and current, when used in conjunction with the cathode catalyst and fuel, that is desired for the application;
(ii) that the cathode catalyst reduces the cathode fuel at a potential and at a rate that produces the cell voltage and current, when used in conjunction with the anode catalyst and fuel, that is desired for the application;
(iii) that the anode and cathode catalysts are available in sufficient quantities and with economics appropriate for the application; and
(iv) that the anode catalyst and cathode catalyst reactions with the anode and cathode fuels, respectively, can be maintained at appropriate voltages and rates for a time period and/or duty cycle that is desired for the application.

The electrolyte (typically comprising an electrolyte salt and supporting solvent) is then selected using a number of criteria:

(i) that the electrolyte is of sufficient ionic conductivity to support the desired cell potential and current;
(ii) that the electrolyte salt and solvent do not interfere with the reactions between the electrodes and their corresponding fuels, or otherwise foul the electrodes;
(iii) that the electrolyte is available in sufficient quantities and with economics appropriate for the application; and
(iv) that, in the case where an electrode is positioned at the interface between the electrolyte and the corresponding fuel, the electrolyte can be matched with an anode or cathode current collector and/or with an appropriate gaseous fuel pressure, so that it does not flood the current collector.

For example, trickle charging a lithium ion cell phone battery is selected as the desired application. Ethanol is selected as the anode fuel due to its wide availability, portability, safety, and low cost, and oxygen is selected as the cathode fuel due to its wide availability and low cost as a component of ambient air. Subsequently, the anode catalyst is selected to be palladium, which is known to oxidize alcohols in alkaline media at about −0.5 V vs. a standard calomel electrode. Cobalt is selected as the cathode catalyst because it is known to reduce oxygen at about +0.5 V vs. a calomel hydrogen electrode. Both catalysts are available in quantities sufficient for the application, based on annual worldwide mining production data.

Alternately, the fuel cell may comprise an anode electrode, a single compartment containing an electrolyte, fuel and cathode reactant, where the anode and cathode electrodes are physically separated with a mechanical or porous separator, which allows liquid to pass freely, to maintain electrode potential. Preferably, the separator is made from porous polyetheretherketone or PEEK.

The disclosed fuel cell is distinguished, in part, by the absence of the permselective membrane or other chemical barrier between the anode and cathode. Removal of this permselective membrane is possible because the anode and cathode catalysts are chosen, together with their fuels and the supporting electrolyte, so that the anode and cathode fuels and the fuel cell electrolyte can intermingle without substantial chemical reaction. As a result, oxidation of the anode fuel and reduction of the cathode fuel occur to a substantial extent only at the anode and cathode, respectively, and without interference from the other fuel.

### Permselective Membrane-Less Fuel Cell Process

The present disclosure provides a method and system for providing a fuel cell that does not have a permselective membrane. As such, the disclosed process for making a permselective membrane-less fuel cell having the requisite power densities relies on use of catalysts and fuels that react independently to a degree required by a commercial application. For example, in a first embodiment a fuel cell comprises a palladium-based anode assembled together with an ethanol fuel dispersed in an alkaline electrolyte and a cobalt-based cathode. Regardless of the operating rate of the resultant fuel cell, the presence of the oxygen fuel for the cathode in the alkaline electrolyte does not affect appreciably the operation of the anode, and as such the anode catalyst reacts with the anode fuel independently of the cathode.

Alternately, a second embodiment is a fuel cell having a platinum-based anode assembled together with hydrogen fuel dissolved in an acidic electrolyte and a cobalt-based cathode. The resultant fuel cell is then operated in such a manner so that all of the cathodic fuel, oxygen, is consumed at the cathode as does not enter the electrolyte and interfere appreciably with the anodic reaction. As a result, the anode catalyst reacts with the anode fuel independently of the cathode. In some cases, including very short term commercial applications requiring less than ten hours of operating time, this use of cathodic consumption of fuel to avoid depolarization of the cell is effected for systems in which the cathode does not consume all of the cathodic fuel and some dissolution of cathodic fuel into the electrolyte occurs. In these cases, since appreciable depolarization of the cell resulting from such dissolution, and subsequent reaction at the anode, of the cathodic fuel occurs over a timeframe longer than the operating timeframe of the cell, the depolarization has little or no effect on the commercial performance of the cell.

The disclosed liquid fuel cell can be operated by variety fuels, such as alcohols and polyalcohols methanol, ethanol, ethylene glycol, glycerol and combinations, and aldehydes such as formaldehyde. The fuel concentration is from 0.5-20M. An alkaline electrolyte is used. The operating temperature is from room temperature to 80° C. The fuel cell runs preferably at ambient pressure to reduce the parasitic power consumption. One method of liquid fuel supply is continuously flow feed, dose feed, or dead-end (passive mode) feed. Method of air supply can be either forced air flow or breathing (passive mode).

### Catalyst Composition and Structure

The present disclosure further provides fuel cells containing a wide range of anode catalysts, including platinum, palladium, nickel, copper, silver, gold, iridium, rhodium, cobalt, iron, ruthenium, osmium, manganese, molybdenum, chromium, tungsten, vanadium, niobium, titanium, indium, tin, antimony, bismuth, selenium, sulfur, aluminum, yttrium, strontium, zirconium, magnesium, lithium, and oxides thereof. The anode catalysts are preferably in their pure forms, as binary mixtures or alloys, as ternary mixtures or alloys, as quaternary mixtures or alloys, or are higher order mixtures or alloys. Alternatively, the anode catalysts are in their oxidized forms, as oxides, as sulfides, and as metal centers for coordination compounds including phosphorous-based ligands, sulfur-based ligands or other ligands. Alternatively, the anode catalysts are present in a conducting medium such as carbon powder.

In a preferred embodiment the present disclosure provides fuel cells containing anode catalysts based on such elements, or their alloys and mixtures, or their oxides, sulfides or coordination compounds, in their pure or dispersed forms, that are formed into particles that have at least one dimension that is less than 100 nanometers in length. Such particles can be spherical in nature, such as five nanometer diameter palladium nanoparticles immobilized onto carbon particles, or can be of other structures and morphology, such as ten micron long palladium-coated carbon rods that are two nanometers in diameter. Such particles can be mixtures of other particles that have a variety of aspect ratios and structures and compositions. Such particles can be prepared by electroplating onto the anode support.

The disclosure further provides fuel cells containing a wide range of cathode catalysts, including platinum, palladium, nickel, copper, silver, gold, iridium, rhodium, cobalt, iron, ruthenium, osmium, manganese, molybdenum, chromium, tungsten, vanadium, niobium, titanium, indium, tin, antimony, bismuth, selenium, sulfur, aluminum, yttrium, strontium, zirconium, magnesium, lithium, and similar elements. The cathode catalysts based on such elements are in their pure forms, as binary mixtures or alloys, as ternary mixtures or alloys, as quaternary mixtures or alloys, and as higher order mixtures or alloys. The cathode catalysts based on such elements are also alloys and mixtures, in their oxidized forms, as oxides, as sulfides, and as metal centers for coordination compounds including oxygen-based ligands, nitrogen-based ligands, phosphorous-based ligands, sulfur-based ligands or other ligands. The cathode catalysts based on such elements are alloys and mixtures, in their pure form or physically and/or chemically dispersed in some manner in a conducting medium such as carbon powder. The cathode catalysts based on such elements are alloys and mixtures, or their oxides, sulfides or coordination compounds, in their pure or dispersed forms, that are formed into particles that have at least one dimension that is less than 100 nanometers in length. Such particles can be spherical in nature, such as five nanometer diameter palladium nanoparticles immobilized onto carbon particles, or can be of other structures and morphology, such as ten micron long palladium-coated carbon rods that are two nanometers in diameter. Such particles can be mixtures of other particles that have a variety of aspect ratios and structures and compositions. Such particles can be prepared by electroplating onto the cathode support.

In one embodiment, a cathode is made with MnO₂ on carbon as the catalyst material. The catalyst material is added onto a carbon electrode and then coated with PTFE. The catalyst was made by adding together potassium permanganate (KMnO₄), carbon (Vulcan X72R, Cabot Corp., Billerica, Mass.) and dI (deionized) water. Aliquots of carbon particles were added to dI water at around 60° C. while stirring to make a slurry. KMnO₄ was added in aliquots to the suspension. The pH is adjusted (sulfuric acid to pH 7) and the slurry is stirred at room temp. After the pH adjustment, the oxidation of the carbon by permanganate will form manganese dioxide catalyst on the carbon particles. The suspension is filtered, washed with dI water, and then dried overnight. At 80° C. for form a dry powder. The dry powder is ground in a ball mill into a fine powder. Analysis by XRay and EDX showed no impurities and 5-20% by weight Mn in the MnO₂ catalyst material.

The fine powder is inked onto carbon paper having a microporous layer (PTFE in alcohols) sprayed on. For the PTFE treatment of carbon paper electrodes, a 60% (w/v) solution of PTFE was diluted to 5% (w/v). Carbon paper was soaked in this 5% solution for 1 min with excess 5% PTFE solution removed. The soaked carbon paper was put onto a drying rack at room temp overnight. The dried coated carbon paper is put in an oven at 110° C. for at least 30 min and then the temperature increased to 350° C. for at least 45 min. This procedure is repeated but the paper soaks for longer periods of time in the 5% solution of PTFE because it is now more difficult to impregnate. Quality is checked by spotting with EtOH (50-70% solution in water) so that the carbon paper is not penetrated.

In a preferred embodiment, the anode uses a Pd on carbon catalyst, (BASF) which also uses carbon (Vulcan X72R, Cabot Corp., Billerica, Mass.)

### Support

The anode and cathode are made with porous support structures. The anode supports comprise one or more conducting materials prepared in a sheet, foam, cloth or other similar conductive and porous structure. The support can be chemically passive, and merely physically support the anode catalyst and transmit electrons from it, and/or it can be chemically or electrochemically active, assisting in the anode reaction, in pre-conditioning of fuel, in post-conditioning of anode reaction products, in physical control of the location of the electrolyte and other fluids, and/or in other similarly useful processes. Anode supports can include, for example, nickel foam, sintered nickel powder, etched aluminum-nickel mixtures, carbon fibers, and carbon cloth. Preferably, nickel foam is used as an anode support.

The cathode supports comprise one or more conducting materials prepared in a sheet, foam, cloth or other similar structure. The cathode support can be chemically passive, and merely physically support the cathode catalyst and transmit electrons to it, and/or it can be chemically or electrochemically active, assisting in the cathode reaction, in pre-conditioning of fuel, in post-conditioning of cathode reaction products, in physical control of the location of the electrolyte and other fluids, and/or in other similarly useful processes. Cathode supports can include nickel foam, sintered nickel powder, etched aluminum-nickel mixtures, metal screens, carbon fibers, and carbon cloth.

The disclosed fuel cells comprise anode and/or cathode supports that have been pre-treated in order to control flooding of the cathode. For example, a preferred fuel cell contains a cathode support comprised of carbon fiber that has been pre-treated by teflonization of carbon fiber paper. Briefly, the desired concentration of PTFE (30-60 wt %) was prepared and stirred gently for at least 2 hours before use. Teflonization of the carbon fiber paper was done by laying the carbon fiber paper pieces flat in the PTFE solution for 30 seconds, making sure that the carbon fiber pieces were fully submerged. After 30 seconds, each piece was removed from solution and allowed to drip off for about 1 minute before laying them on a rack to dry for an hour at room temperature. Once dried, the PTFE treated carbon paper was sintered in a furnace, set to 335° C., for 15-20 minutes. Alternatively, a microporous layer (MPL) on carbon paper spray method was also employed. Briefly, about 140 mg of pre-treated carbon power was provided and about 1 mL water and 0.2 mL Triton X-100 was added to form a solution. The solution was sonicated for about 30 seconds. About 100 mg of 60 wt % PTFE solution was added to the solution and the solution further sonicated for about 10 minutes, stopping about halfway through to mix the solution with a glass rod. The carbon fiber paper (treated with PTFE) was attached to a backing so that it stands upright in a hood. Once the ink is prepared, the ink is transferred to an airbrush bottle, and sprayed onto carbon paper in thin, even layers, allowing time for each layer to dry before the next is applied. This process was continued until the ink is used up. The sprayed carbon paper was dried in the oven at 80° C. for 30 minutes. Once dried, the sprayed and dried carbon paper pieces were situated between aluminum foil squares and the MPL firmly pressed by running a roller over it 2-3 times. Next, the carbon paper was sintered by returning it to the oven, set to 120° C. for 10 minutes, and then to the furnace, set to 340° C. for 15 minutes. This pre-treatment provided a cathode support that was sufficiently hydrophobic so that the electrolyte, solvent and anode fuel contained in the single compartment does and did not flood the cathode and thereby interfere with the reduction of oxygen at the cathode catalysts.

A similar pre-treatment for an anode support can be carried out in order to likewise contain the electrolyte for a cell that uses a gaseous anodic fuel.

With these pre-treatments, there is disclosed a method by which membrane-free fuel cells are produced that operate independent of their physical orientation. For example, inferior fuel cell designs that address flooding of the cathode by floating the cathode on the top of the fluid in the single compartment, and thereby uses gravity to reduce the flow of fluid through the cathode support, cannot be oriented so that the cathode is below the single compartment or horizontal to the single compartment. The present disclosure provides a fuel cell that can be oriented in any direction due to its use of pre-treated electrode supports to control flooding of the cathode.

### Catalyst Application Options

Methods for applying the anode catalysts to the anode support and cathode catalysts to the cathode support include, for example, spreading, wet spraying, powder deposition, electrodeposition, evaporative deposition, dry spraying, decaling, painting, sputtering, low pressure vapor deposition, electrochemical vapor deposition, tape casting, and other methods.

### Separators

A key component of the disclosed fuel cell is anon-conducting separator that does not preclude appreciably free movement within a single compartment of the electrolyte, solvent, and any liquid anodic or cathodic fuel. Preferably, this separator is chemically inert to the materials present in the single compartment and physically inert to the temperatures, pressures, and chemical conditions present in the single compartment. This chemical and physical inertness of the separator is substantial at least over the desired lifetime of the fuel cell.

In some cases, the lack of inertness of a separator to a chemical or physical environment in the single compartment is used to determine a maximum lifetime of the fuel cell or to create a safety mechanism for a fuel cell. For example, a separator that degrades over time until it interferes substantially with ionic movement between the cathode and anode after 100 hours of operation of a fuel cell can be used to set the maximum lifetime of the cell at 100 hours. However, the disclosed fuel cell has been operating continuously for over four thousand hours.

In another example, a separator that melts and interferes substantially with ionic movement between the cathode and anode if the temperature in the single compartment exceeds 40° C. can be used to set the maximum operating temperature of the cell at 40° C.

Examples of separators include dielectric materials such as polymers, glasses, mica, metal oxide, cellulose, and ceramics, among others. Such separators can be constructed as porous sheets or as uniformly-sized particles. In a preferred embodiment, the separator is a fixture surrounding the edges of the anode and cathode that holds the anode and cathode at a fixed distance apart while providing a containing shell between the electrodes that contains the electrolyte, solvent and fuel fluids so that they remain between the anode and cathode, and thereby creates the single compartment of the fuel cell.

In a preferred embodiment, a fine PEEK (polyetheretherketone) mesh is used as the separator. The separator is placed between an anode catalyst layer and a cathode catalyst. The edge of the PEEK mesh preferably is either pre-sealed or integrated with the cell sealing to prevent overboard leaking. Preferably, the thickness of the PEEK mesh is 2-3 mm thick.

### Fuels

The present disclosure provides a membrane-less fuel cell that uses any fuel that is oxidized or reduced at the anode or cathode, respectively, at a desired rate and without appreciable interference with other materials in the cell over the desired lifetime of the cell. Examples of fuels that can be utilized include hydrogen, alcohols such as methanol and ethanol, metal hydrides, chemical hydrides, ammonia, natural gas, hydrocarbons such as methane, propane, and butane, polyalcohols such as ethylene glycol and glycerol, aldehydes such as formaldehyde and acetaldehyde, dimethyl ether, hydrazine, gasoline, diesel fuel, energetic materials such as trinitrotoluene and RDX, and bio-fuels, among others.

Such fuels are introduced into the disclosed membrane-less fuel cell as solids, liquids or gases, are carried into the fuel cell by structures such as carbon nanotubes, are generated in the fuel cell from precursors such as sodium borohydride, or are carried into the fuel cell as slurries, solutions or similar mixtures. Such fuels result from chemical or physical reformation of other fuels, such as reforming hydrogen from natural gas, and/or from electrochemical processes such as electrolysis of water to produce hydrogen. The fuels are introduced into the fuel cell at various concentrations, and by providing the fuels, for example, by filling the single compartment with anode and/or cathode fuel only once. Alternatively, one or more fuels are provided to the fuel cell on a continuing basis, for example, by allowing fresh ambient air to reach the cathode throughout the lifetime of the cell. Alternatively, one or more fuels are gaseous and are compressed or hydrated. Alternatively, the gaseous or liquid fuels are pressurized by the fuel cell user when higher fuel cell performance is needed. For example, for a fuel cell that acts as a trickle charger for a mobile phone, the mobile phone user can repeatedly push on a one way valve that pressurizes the cathodic fuel, ambient air, and causes the rate of reduction of oxygen at the cathode to increase, thereby causing the current from the fuel cell to increase and the mobile phone battery to recharge at a faster rate.

A preferred fuel is ethanol. However, mixed alcohol fuels can also be used. Other fuels that can be used in a fuel mixture are, for example, short chain alcohols (such as ethanol, methanol, propanol and isopropanol), sodium borohydride and hydrazine. When ethanol is used as the fuel, the spent fuel is acetic acid or acetate. When methanol is used as the fuel, the disclosed fuel cell forms formic acid or formate. Similarly, when propanol is used, it forms propionic acid or propionate.

### Electrolytes and Solvents

The disclosure provides a fuel cell in which the anode and cathode catalyst-fuel systems are chosen so that they can operate independently even when the fuels are mixed. The solvent and electrolyte used in the fuel cell have a significant effect on the electroactivities of the anode and cathode catalyst-fuel systems. The solvent and electrolyte facilitate those electroactivities, have no effect on the electroactivities, or reduce the electroactivities. For example, ethanol is oxidized at palladium in alkaline aqueous media. In this case, the present fuel cell uses a water solvent that contains a strong base to facilitate oxidation of ethanol at the palladium catalyst. Selection of a cathode catalyst-fuel system that can operate in alkaline media is important.

Solvents and electrolytes interact with the anodic fuel to facilitate the electroactivity of that fuel at the anode. The solvent and electrolyte interact with the cathodic fuel to facilitate the electroactivity of that fuel at the cathode. The concentration of electrolyte is chosen to facilitate electroactivity of one or more of the fuels, to minimize adverse interactions between the electrolyte and one or more of the catalysts, to maximize ionic conductivity and current density of the fuel cell, and to minimize acidity or alkalinity (i.e., safety concerns) of the fuel cell.

Examples of electrolytes include dissolved salts such as bases like potassium hydroxide, NaOH, K₂CO₃, Na₂CO₃, NH₄.OH, acids such as sulfuric acid, sulfonic acid, and combinations thereof.

### Various Embodiments

In one embodiment, 5 grams of 10% platinum on carbon nanoparticulate powder was dispersed in isopropanol. The paste was pressed into a nickel foam support and dried in air to produce the anode. 5 Grams of 10% cobalt in carbon powder was likewise dispersed in isopropanol. The paste was pressed into a carbon fiber support and dried in air to produce the cathode. The electrodes were positioned with a porous separator sandwiched between them, wherein the catalysts in both electrodes were oriented toward the separator between them. The back of the porous carbon fiber cathode support was exposed to ambient air and a fuel and electrolyte mixture containing 10% methanol in a 10% KOH and water mixture was introduced into the compartment formed by the porous separator between the electrodes. A wire lead was connected from the anode support to an electrical load. Another wire lead was connected from the electrical load to the cathode support. The fuel cell then commenced to perform work, providing 20-60 mW per cm². However, while a Pt catalyst performed, there are other catalyst systems of equal or greater performance that do not have the high cost of Pt.

In a preferred embodiment, 2.5 grams of 10% Pd on carbon nanoparticles and 2.5 grams of 10% titanium oxide nanoparticle powder were dispersed in isopropanol. The paste was pressed into a carbon fiber support and dried in air to produce the anode. 5 Grams of 10% MnO₂ in carbon powder was likewise dispersed in isopropanol. The paste was pressed into a carbon fiber support and dried in air to produce the cathode. The electrodes were positioned with a porous separator sandwiched between them, wherein the catalysts in both electrodes were oriented toward the separator between them. The back of the porous carbon fiber cathode support was exposed to ambient air and a fuel and electrolyte mixture containing 10% methanol in a 10% sulfuric acid and water mixture was introduced into the compartment formed by the porous separator between the electrodes. A wire lead was connected from the anode support to an electrical load. Another wire lead was connected from the electrical load to the cathode support. The fuel cell then commenced to perform work, providing 20-60 mW per cm².

In a preferred embodiment, 2.5 grams of 10% gold on carbon nanoparticles and 2.5 grams of 10% titanium oxide nanoparticle powder were dispersed in isopropanol. The paste was pressed into a carbon fiber support and dried in air to produce the anode. 5 Grams of 10% cobalt in carbon powder was likewise dispersed in isopropanol. The paste was pressed into a carbon fiber support and dried in air to produce the cathode. The electrodes were positioned with a porous separator sandwiched between them, wherein the catalysts in both electrodes were oriented toward the separator between them. The back of the porous carbon fiber cathode support was exposed to ambient air and a fuel and electrolyte mixture containing 10% methanol in a 10% sulfuric acid and water mixture was introduced into the compartment formed by the porous separator between the electrodes. A wire lead was connected from the anode support to an electrical load. Another wire lead was connected from the electrical load to the cathode support. The fuel cell then commenced to perform work, providing 20-60 mW per cm².

In a preferred embodiment, 4.5 grams of 10% platinum on carbon nanoparticles and 0.5 grams of nickel oxide nanoparticles were dispersed in isopropanol. The paste was pressed into a carbon fiber support and dried in air to produce the anode. 5 Grams of 10% cobalt in carbon powder was likewise dispersed in isopropanol. The paste was pressed into a carbon fiber support and dried in air to produce the cathode. The electrodes were positioned with a porous separator sandwiched between them, wherein the catalysts in both electrodes were oriented toward the separator between them. The back of the porous carbon fiber cathode support was exposed to ambient air and a fuel and electrolyte mixture containing 10% methanol in a 10% sulfuric acid and water mixture was introduced into the compartment formed by the porous separator between the electrodes. A wire lead was connected from the anode support to an electrical load. Another wire lead was connected from the electrical load to the cathode support. The fuel cell then commenced to perform work, providing 20-60 mW per cm².

In a preferred embodiment, 4.5 grams of 10% palladium on carbon nanoparticles and 0.5 grams of nickel oxide nanoparticles were dispersed in isopropanol. The paste was pressed into a carbon fiber support and dried in air to produce the anode. 5 Grams of 10% cobalt in carbon powder was likewise dispersed in isopropanol (IPA). The paste was pressed into a carbon fiber support and dried in air to produce the cathode. The electrodes were positioned with a porous separator sandwiched between them, wherein the catalysts in both electrodes were oriented toward the separator between them. The back of the porous carbon fiber cathode support was exposed to ambient air and a fuel and electrolyte mixture containing 10% methanol in a 10% sulfuric acid and water mixture was introduced into the compartment formed by the porous separator between the electrodes. A wire lead was connected from the anode support to an electrical, load. Another wire lead was connected from the electrical load to the cathode support. The fuel cell then commenced to perform work, providing 20-60 mW per cm².

In another embodiment, 5 grams of platinum nanoparticles that were less than 2 nm in diameter and that were coated with coordinated ligands that assist in reducing agglomeration of the nanoparticles were dispersed in isopropanol. The paste was pressed into a carbon fiber support and dried in air to produce the anode. 5 Grams of 10% cobalt in carbon powder was likewise dispersed in isopropanol. The paste was pressed into a carbon fiber support and dried in air to produce the cathode. The electrodes were positioned with a porous separator sandwiched between them, wherein the catalysts in both electrodes were oriented toward the separator between them. The back of the porous carbon fiber cathode support was exposed to ambient air and a fuel and electrolyte mixture containing 10% methanol in a 10% sulfuric acid and water mixture was introduced into the compartment formed by the porous separator between the electrodes. A wire lead was connected from the anode support to an electrical load. Another wire lead was connected from the electrical load to the cathode support. The fuel cell then commenced to perform work, providing 20-60 mW per cm². Again, while a Pt catalyst performed, there are other catalyst systems of equal or greater performance that do not have the high cost of Pt.

In a preferred embodiment, 5 grams of platinum nanoparticles that have an aspect ratio of greater than 10, that have a long dimension of less than 40 nm and a short dimension of less than 5 nm, and that were coated with coordinated ligands that assist in reducing agglomeration of the nanoparticles, were dispersed in isopropanol. The paste was pressed into a carbon fiber support and dried in air to produce the anode. 5 Grams of 10% cobalt in carbon powder was likewise dispersed in isopropanol. The paste was pressed into a carbon fiber support and dried in air to produce the cathode. The electrodes were positioned with a porous separator sandwiched between them, wherein the catalysts in both electrodes were oriented toward the separator between them. The back of the porous carbon fiber cathode support was exposed to ambient air and a fuel and electrolyte mixture containing 10% methanol in a 10% sulfuric acid and water mixture was introduced into the compartment formed by the porous separator between the electrodes. A wire lead was connected from the anode support to an electrical load. Another wire lead was connected from the electrical load to the cathode support. The fuel cell then commenced to perform work, providing 20-60 mW per cm². Again, while a Pt catalyst performed, there are other catalyst systems of equal or greater performance that do not have the high cost of Pt.

In a preferred embodiment, 2.5 grams of 10% cobalt on carbon nanoparticles and 2.5 grams of 10% nickel oxide nanoparticle powder were dispersed in isopropanol. The paste was pressed into a carbon fiber support and dried in air to produce the anode. 5 Grams of 10% cobalt in carbon powder was likewise dispersed in isopropanol. The paste was pressed into a carbon fiber support and dried in air to produce the cathode. The electrodes were positioned with a porous separator sandwiched between them, wherein the catalysts in both electrodes were oriented toward the separator between them. The back of the porous carbon fiber cathode support was exposed to ambient air and a fuel and electrolyte mixture containing 10% methanol in a 10% sulfuric acid and water mixture was introduced into the compartment formed by the porous separator between the electrodes. A wire lead was connected from the anode support to an electrical load. Another wire lead was connected from the electrical load to the cathode support. The fuel cell then commenced to perform work, providing 20-60 mW per cm².

A key component is the coated and conductive electrode cathode. The cathode can be made, for example, by immersing carbon paper in a fluoropolymer mixture, such as a Teflon (PTFE) emulsion. Once immersed, the polymer was sintered or heated to its glass transition temperature (347° F.) to make the carbon paper hydrophobic. The catalyst was added by a spray on process or using an air brush.

The disclosed fuel cell can operate due to the selectivity of the catalysts. For example, using a short chain alcohol as the fuel in a 10% (range 2% to 25%) KOH electrolyte solution (from about 2M to about 3M), uses a palladium catalyst on the anode side and a cobalt catalyst on the cathode side. Such a fuel cell can produce steady power output of approximately 20 mW per cm², 40 mW per cm², 20 mW per cm², or 60 mW per cm².

### Stacking

The present disclosure provides separator electrode assembly (SEA) for a permselective membraneless fuel cell that provides improved yields for fuel cell assembly into a unitized assembly and avoids seals and compressions characteristic of MEAs (membrane electrode assemblies) characteristic of permselective membrane-based fuel cells. Specifically, the present disclosure provides a Separator Electrode Assembly (SEA) comprising a plurality of multiple-layered sandwich assemblies located within a chamber, wherein each multiple layered sandwich assembly comprises:

(a) a substantially flat and substantially planar anode having a first and a second side, wherein the first side communicates with a reservoir of fuel; communicating on one side with a flat and planar porous separator that, in turn communicates with a flat and planar cathode

(b) a substantially flat and substantially planar porous separator having a first side and a second side and that allows passage of liquids relatively unimpeded, wherein the first side of the porous separator communicated with the second side of the anode; and

(c) a substantially flat and substantially planar cathode having a first and a second side, wherein the first side communicates with the porous separator and the second side communicates with air or an oxygen gas source, wherein the cathode further comprises a hydrophobic coating; and

wherein the chamber comprises an enclosed chamber having liquid fuel in communication with the first side of each anode and air or oxygen gas in communication with the second side of each cathode.

Preferably, the chamber is form with a circumferential thermoplastic assembly formed under melt-flow conditions. Preferentially, the SEA is further sealed to a bipolar plate to form a unitized assembly. Such a unitized assembly can be formed by stacking a plurality of SEA's to provide power output of the unitized assembly that is additive with each SEA.

Specifically, each SEA is stacked, anode-to-cathode, with a bipolar plate located in between. This creates channels for flow of fuel/electrolyte to flow into each anode side of an SEA and air or oxygen to flow on the cathode side of each SEA.

For example, when using ethanol in KOH as the fuel/electrolyte, the theoretical power output of such a stacked device was calculated to be 1.17 V when forming acetic acid. Yet power outputs of 0.85-0.95 V have been achieved. The high outputs relative to theoretical maximums was achieved due to reduced shorting due to serial flow or rather, non-parallel flow of the fuel/electrolyte solution (which otherwise is conductive).

Preferably, the bipolar plates use a coating (such as a polymer membrane, enamel or other electrically insulating that covers the bipolar plate except for an inlet hole. Flow paths are serial. Each bipolar plate is a two-sided sheet with insulating coating on both sides. On one side of the bipolar plate (the side adjacent to the cathode or the “cathode side”) flows the fuel/electrolyte and on the other side (the “anode side”) flows air/oxygen in a perpendicular direction (to the electrolyte/fuel flow path). This flow direction reduces shorting losses by minimizing surface area and maximizing distance between electrolyte openings (as the fuel/electrolyte solution is conductive).

### Example 1

This example provides process for the preparation of anode electrodes. The disclosed permselective membraneless fuel cell anode electrodes are prepared by applying an anode catalyst onto a substrate. The anode catalyst can be, for example, metal black, metal with carbon supported, or metal alloy. Examples of appropriate metals include, but are not limited to Pt, Pd, Rh, Ru, W, Ir, and combinations or alloys or oxides thereof. The substrates are preferably electrically conductive, porous, chemically/mechanically stable and non-hydrophobic. Examples of such electrically conductive, porous, chemically/mechanically stable and non-hydrophobic substrates include, for example, Ni foam, carbon foam, stainless steel foam, carbon fiber paper, carbon cloth, and combinations thereof.

The present example provides three methods used to prepare anode electrodes. The first method is a catalyst paste method. The second method is a catalyst ink method. The first two methods use Ni foam substrate. The third method use carbon fiber paper.

A catalyst ink method first directly mixed a Pd catalyst or a Pd catalyst with a metal oxide with a polyfluorinated polymer (e.g., Teflon). A, loading range of from about 0.1 mg/cm² to about 10 mg/cm² of carbon supported Pd catalyst (e.g., BASF 30% Pd), or Pd black, or pre-mixed with metal oxide (e.g., tin oxide) is mixed with PTFE (1-70%) in an alcohol solvent (e.g., ethanol). Specifically, 100 mg 30% Pd supported on carbon from BASF was mixed with 100 mg metal oxides (e.g., 10% CoO_{X}/C) supported on carbon. Then, 20 ml of 95% ethanol was added and the mixture was shaken and sonicated for 30 minutes. The suspension was then subjected to evaporation at temperature 40˜90° C. to obtain a well mixed Pd/C and CoO_{X}/C solid. Into this solid mixture, about 1 mL of proper amount (to form a better consistency of the final paste product) of 95% ethanol containing 0.5% PTFE as binder was added into the mixture and carefully stirred. The obtained uniform catalyst paste was then spread onto 5 cm² nickel foam substrates. The estimated loading of Pd on the nickel foam substrate was 6 mg/cm². Different Pd loading on nickel foam can be obtained in the same way by adjusting the amount of Pd/C and CoO_{X}/C used.)

Generally, this solution is mixed by vigorous stirring or subject to ultrasound for 10-300 minutes until a uniform catalyst slurry is formed. The uniform catalyst slurry is next concentrated by evaporating the solvent until a paste is formed. When ethanol is used as the solvent, the evaporation is optimally conducted at 40-90° C. until the paste is formed. The paste formed was then “pasted” (i.e., bladed or spread) onto a substrate to form an anode electrode. Preferably, Ni foam was used as the substrate.

The second method is a catalyst ink method. This method directly mixes a carbon-supported Pd catalyst (e.g., BASF 30% Pd) or a Pd black, or pre-mixed with a metal oxide (e.g., tin oxide) with isopropyl alcohol (IPA) and ethanol containing Nafion® (1-70%). The solution is mixed, preferably by ultrasonic stirring for 10-300 minutes, and a uniform catalyst slurry is formed. The substrate (preferably Ni foam) is first heated, preferably to 40-90° C., and then the catalyst slurry is dripped using a dropper or Pasteur Pipette to evenly apply the catalyst slurry to the Ni foam. It is recommended to not apply too much slurry to the Ni foam at once. Preferably, one coat at a time should be applied and allowed to dry (about 5 min at ambient temperature) before adding another coat.

The third method uses a carbon fiber paper. This method directly mixes a carbon-supported Pd catalyst (e.g., BASF 30% Pd) or a Pd black, or pre-mixed with a metal oxide (e.g., tin oxide) with a loading range from 0.1-10 mg/cm² of Pd catalyst with a fine Ni powder. IPA in ethanol is added and the solution is subject to ultrasonic stirring for 10-300 minutes to form a uniform catalyst slurry. The uniform catalyst slurry is inked by adding Nafion® (1-70% by weight) and stirred with the aid of ultrasound for 10-300 minutes to form a uniform catalyst ink. The uniform catalyst ink is applied to carbon fiber paper by using either the pasting or the dripping methods described above.

### Example 2

This example provides a method to prepare cathode electrodes by applying a cathode catalyst to a substrate. The cathode catalyst can be metal oxide black, metal oxide with carbon supported, or metal oxide mixture. The substrates preferably are electrical conductive, porous, chemically/mechanically stable and hydrophobic. Preferably, a micro porous layer (MPL) may be used to improve the oxygen transport.

There are disclosed two methods to prepare the cathode electrodes in our experiments. The first method is a catalyst paste method that formed a carbon fiber paper cathode electrode with polytetrafluorinated ethylene (PTFE) treatment and a microporous layer (MPL) coated as substrate. Cathode catalyst, such as manganese oxide, activated carbon, cobalt oxide, Ni oxides, copper oxides, silver oxides, iron oxides, chrome oxide, and combinations thereof (all commercially available) in a range of from about 0.1 to about 10 mg/cm² was mixed with water (0-20% by weight) and ethanol (10-98% by weight) and stirred with ultrasound for at least 15 minutes to mix the solution that is formed. A PTFE solution (30% by weight) was added at a range from about 1% to about 70% by weight to from a slurry and the slurry was mixed for at least 10 minutes, preferably up to 300 minutes to form a catalyst ink slurry. The catalyst ink slurry was dripped (dropper or Pasteur pipette) to provide the catalyst ink slurry evenly to a substrate, such as PTFE treated carbon fiber paper with MPL. One coat was applied at a time and allowed to dry for 5-10 minutes in an oven (temperature setting was 65° C.) before adding another coat. After adding the catalyst slurry to the substrate to form a cathode, the cathode was dried (40-90° C. for 10-45 minutes), pressed (roll press the cathode to increase the density of catalyst layer), further dried (at 120° C. for an hour), and sintered (200-450° C. for 30-200 minutes).

The second method is catalyst ink method. A current collector (preferably, a fine metal mesh) was integrated into a cathode electrode and a thin micro porous PTFE film was used as a backing layer. It was not necessary to use carbon fiber paper with PTFE treatment and MPL coated as substrate. The catalyst ink method first dispersed cathode catalyst (see above for a list of cathode catalysts) at a loading range from 0.1-10 mg/cm² was mixed with water (0-20% by weight) and ethanol (10-98% by weight) and stirred with ultrasound for at least 15 minutes to mix the solution that is formed. A PTFE solution (30% by weight) was added at a range from about 1% to about 70% by weight to from a slurry and the slurry was mixed for at least 10 minutes, preferably up to 300 minutes to form a catalyst ink slurry. The catalyst ink slurry was dripped onto a fine metal mesh placed on top of a thin micro porous PTFE film. The catalyst ink slurry was dripped (dropper or Pasteur pipette) to provide the catalyst ink slurry evenly to the fine metal mesh. One coat was applied at a time and allowed to dry for 5-10 minutes in an oven (temperature setting was 65° C.) before adding another coat. The cathode was dried at 40-90° C. for 10-45 minutes, hot pressed at 50-150° C. and 20-120 psi for 1-10 minutes, and then sintering at 200-450° C. for 30-200 minutes.

### Example 3

This example illustrates the disclosed fuel cell configuration. The liquid fuel cells were assembled to place a porous separator between the cathode and anode electrode. It was not necessary to use an ion exchange membrane (cation or anion) as a separator. The separator preferably was thin, micro porous, wetable, chemically/mechanically stable, and not electrically conductive. Appropriate separators include, for example, mesh, glass frets, polyetheretherketone (PEEK). Preferably, a PEEK mesh was used as a separator. Current collectors are preferably used at both cathode and anode to collect fuel cell current.

The disclosed liquid fuel cells are also built as a “double-cell” configuration. This configuration comprises a cell having two sides, with two cathodes on each of the two sides, and a shared anode/fuel reservoir in between the two cathodes. This configuration provides an advantage by significantly reducing the fuel cell size and weight, while increasing the output power density.

We claim:

1. A fuel cell that lacks a permselective membrane, comprising:
(a) an enclosed fuel cell having an anode chamber and a cathode chamber, wherein the anode chamber is separated from the cathode chamber by a mechanical/electrical porous separator that allows the free transfer of liquids and ions between the chambers;
(b) the anode chamber comprises an anode electrode having a catalyst thereon, and a mixture of fuel and an electrolyte; and
(c) the cathode chamber comprises a hydrophobic coated cathode electrode having a catalyst thereon and oxygen gas; and
wherein the anode electrode and the cathode electrode are electrically connected to leads for current flow, and wherein the enclosed fuel cell is capable of producing at least 10 mA/cm².

2. The fuel cell that lacks a permselective membrane of claim 1 wherein the fuel cell is capable or current densities of at least 15 mA/cm², or at least 20 mA/cm², or at least 25 mA/cm², or at least 30 mA/cm², or at least 35 mA/cm², or at least 40 mA/cm², or at least 1 A/cm².

3. The fuel cell that lacks a permselective membrane of claim 1 wherein the catalyst on the anode electrode is present at a density of no more than 1 mg/cm².

4. The fuel cell that lacks a permselective membrane of claim 1 wherein the fuel cell has a rate of voltage decay of less than 1 μV/hr in a continuous operation.

5. The fuel cell that lacks a permselective membrane of claim 4 wherein the fuel cell has a rate of voltage decay of about 50 μV/hr in a continuous operation.

6. The fuel cell that lacks a permselective membrane of claim 1 wherein the fuel cell can operate in any orientation, or with the fuel/electrolyte mixture pumped or added in a batch system.

7. The fuel cell that lacks a permselective membrane of claim 1 wherein the fuel cell output is at least 2 mW/cm².

8. The fuel cell that lacks a permselective membrane of claim 1 wherein the fuel mixture comprises an alcohol or poly-alcohol at a concentration of from about 5% (by volume) to about 50% (by volume).

9. The fuel cell that lacks a permselective membrane of claim 8 wherein the fuel is ethanol or methanol.

10. The fuel cell that lacks a permselective membrane of claim 1 wherein the coated electrode cathode is coated by a hydrophobic polymer selected from the group consisting of polyamides, polyimides, fluoropolymers, organosubstituted silica, organo-substituted titania, and combinations thereof.

11. The fuel cell that lacks a permselective membrane of claim 1 wherein the fuel cell operates at a temperature less than 40° C.

12. The fuel cell that lacks a membrane of claim 11 wherein the temperature is from about 20° C. to about 40° C.

13. A fuel cell comprising:
(a) an anode compartment comprising a fuel mixture, an anode electrode and an anode catalyst, wherein the fuel is aqueous and mixed with an electrolyte, and wherein the anode electrode is a carbon paper electrode having catalyst particle embedded therein;
(b) a cathode compartment having an air inlet, a conductive and coated electrode cathode, wherein the cathode electrode coating is hydrophobic, and wherein a catalyst material is further embedded within the conductive coated cathode electrode; and
(c) a porous separator located between the anode and the cathode that allows for the free movement of aqueous liquids.

14. The fuel cell of claim 13, wherein the conductive cathode electrode coated hydrophobic material prevents flooding of the cathode.

15. The fuel cell of claim 13, wherein the fuel mixture comprises an alcohol or polyalcohol at a concentration of from about 5% (by volume) to about 50% (by volume).

16. The fuel cell of claim 15, wherein the fuel is ethanol or methanol.

17. The fuel cell of claim 13, wherein the coated electrode cathode is coated by a hydrophobic polymer selected from the group consisting of polyamides, polyimides, fluoropolymers, organosubstituted silica, organo-substituted titania, and combinations thereof.

18. The fuel cell of claim 13, wherein the porous separator is a porous ceramic, glass fiber or woven porous sheet.

19. The fuel cell of claim 13, wherein the fuel cell is capable or current densities of at least 15 mA/cm², or at least 20 mA/cm², or at least 25 mA/cm², or at least 30 mA/cm², or at least 35 mA/cm², or at least 40 mA/cm², or at least 1 A/cm².

20. The fuel cell of claim 13, wherein the fuel cell has a rate of voltage decay of less than 1 V/hr.

21. A separated cell assembly for a permselective membrane-less fuel cell running on an alcohol or polyalcohol fuel in an electrolyte, comprising a separated cell assembly and a fuel reservoir, wherein the separated cell assembly comprises:
(a) a porous flat separator sheet having a thickness of from about 1 mm to about 10 mm and having an anode side and a cathode side;
(b) flat sheet anode composed of a porous conductive substrate and having a fuel reservoir side and a separator side and having anode catalyst material layered on the separator side of the anode; and
(c) a flat sheet cathode composed of a porous conductive substrate, having an air side and a separator side, having a microporous layer of hydrophobic material on the separator side and having a catalyst suffused on the air side and within the porous conductive substrate;
wherein the flat sheet anode and the flat sheet cathode form a sandwich with the porous flat separator within to form the separated cell assembly, and wherein the areas of the flat sheets of the anode, cathode and porous separator are substantially the same and substantially aligned.

22. The separated cell assembly for a permselective membrane-less fuel cell of claim 21, wherein the porous flat separator sheet has a thickness of from about 1.5 mm to about 4 mm.

23. The separated cell assembly for a permselective membrane-less fuel cell of claim 21, wherein the porous flat separator sheet is a woven or non-woven mesh made from a material that is chemically inert to the fuel and electrolyte mixtures.

24. The separated cell assembly for a permselective membrane-less fuel cell of claim 21, wherein the porous flat separator sheet is made from polyetheretherketone (PEEK).

25. The separated cell assembly for a permselective membrane-less fuel cell of claim 21, wherein the flat sheet anode is made from a conductive foam such as a Ni foam.

26. The separated cell assembly for a permselective membrane-less fuel cell of claim 21, wherein the flat sheet anode uses a catalyst comprising a metal particle coating a roughly spherical carbon particle.

27. The separated cell assembly for a permselective membrane-less fuel cell of claim 21, wherein the flat sheet anode catalyst is Pd.

28. The separated cell assembly for a permselective membrane-less fuel cell of claim 21, wherein the flat sheet cathode is a conductive carbon fiber that is either woven or non-woven in a paper.

29. The separated cell assembly for a permselective membrane-less fuel cell of claim 21, wherein the hydrophobic material that forms a macroporous layer on the separator side of the cathode is made from PTFE (polytetrafluoro ethylene).

30. The separated cell assembly for a permselective membrane-less fuel cell of claim 21, wherein the fuel is ethanol and the electrolyte is potassium hydroxide.
